(19) United States
(12) Patent Application Publication
(10) Pub. No.: US 2024/0271303 A1
(43) Pub. Date: Aug. 15, 2024

(54) ELECTROCHEMICAL SYSTEM AND METHOD FOR SELECTIVE RECOVERY OF GOLD FROM ELECTRONIC WASTE AND MINING STREAMS

(71) Applicant: The Board of Trustees of the University of Illinois, Urbana, IL (US)

(72) Inventors: Xiao Su, Champaign, IL (US); Stephen R. Cotty, Champaign, IL (US)

(21) Appl. No.: 18/436,586

(22) Filed: Feb. 8, 2024

Related U.S. Application Data
(60) Provisional application No. 63/444,334, filed on Feb. 9, 2023.

(51) Int. Cl. C25C 1/20; C25C 7/02; C25C 7/04; C25C 7/08

(52) U.S. Cl. CPC C25C 1/20; C25C 7/02; C25C 7/04; C25C 7/08

(57) ABSTRACT

An electrochemical system for selective recovery of gold from electronic waste and mining streams includes a vessel configured for flow of fluid therethrough, a working electrode positioned in the vessel, where the working electrode comprises a redox-active metallopolymer, and a counter electrode spaced apart from the working electrode in the vessel. An electrochemical method for selective gold recovery includes selectively electrochemically adsorbing gold complexes from a leach solution onto a redox-active metallopolymer, and electrochemically releasing the gold complexes from the redox-active metallopolymer into a collection fluid.

### RELATED APPLICATION

The present patent document claims the benefit of priority under 35 U.S.C. 119(e) to U.S. Provisional Patent Application No. 63/444,334, which was filed on Feb. 9, 2023, and is hereby incorporated by reference in its entirety.

### FEDERALLY SPONSORED RESEARCH AND DEVELOPMENT

This invention was made with government support under DE-SC0021409 awarded by the Department of Energy. The United States Government has certain rights in the invention.

### TECHNICAL FIELD

The present disclosure is related generally to an electrochemical method and system and more particularly to electrochemical recovery and purification of gold from mining streams and electronic waste.

### BACKGROUND

Since early human history, gold has been synonymous with value, wealth, and stability, and a centerpiece in the development of financial systems. In modern society, gold has become an integral component of electrical and electronic equipment. However, the current production, consumption, and disposal of gold-containing electronics is unsustainable, giving rise to urgent needs for the development of more efficient gold separation technologies. The global virgin gold supply from mining grows ever smaller, as the fraction of gold in the ores has historically declined each year. Despite these challenges, mining operations have increased throughput of low-grade gold ore to match increasing gold demand, resulting in record high resource consumption and carbon emissions per mass of mined gold. With 66% of gold demand met with virgin mined gold currently, the development of a sustainable circular economy for gold, especially through the recycling of used gold-resources such as electronic waste, is sought. Electronic waste has led to an estimated 243 metric tons of gold valued at over $14 billion USD sequestered to landfills annually. The 2015 UN Sustainable Development Goals identified the management of e-waste recycling as a critical milestone to ensure sustainable consumption and production patterns for a circular gold economy, with 77 million metric tons of e-waste predicted to be produced by 2030. As of 2019, only 17.4% of e-waste was recycled globally, and due to ever-increasing consumption rates and lower reparability of electronic products, current recycling efforts are failing to keep pace.

The first step in gold processing from ore and e-waste has traditionally been gold leaching, with the most widespread industrial method of gold leaching being hydrometallurgical cyanidation (e.g., the formation of water-soluble ionic dicyanoaurate, [Au(CN)₂]⁻). However, leaching through cyanidation is non-selective, and a mixture of ionic cyano-metal complexes is formed, with soluble gold complexes present in often hundred-fold excess of competing metallic species, making gold purification an arduous separation challenge. Carbon-in-pulp (CIP) technology is the current commercial standard for concentrating gold ions from leach solution using activated carbon as adsorbent. However, the CIP process is energy-intensive, with severe limitations in molecular selectivity, thus relying on a series of chemical and water demanding pH swing steps to enhance the gold purity, yet ultimately producing only 50% pure gold doré bars. To achieve a commercial grade of >90% purity gold typically requires further refinement with pyrometallurgical methods, requiring highly energy-demanding temperatures over 1500° C. Due to the low selectivity of these gold separation technologies, current methods of refining gold from ore and e-waste to bullion grade (99.5%) are arduous, resource-inefficient, and in the long-term, environmentally-harmful.

### BRIEF DESCRIPTION OF THE DRAWINGS

FIGS. 1A and 1B are schematics of an exemplary electrochemical system and method for separation and recovery of gold complexes.

FIGS. 2A-2C are schematics of alternative embodiments of the electrochemical system.

FIG. 3 shows an exemplary electrochemical system and method for separation and recovery of gold complexes using a working electrode comprising polyvinylferrocene (PVF) and carbon nanotubes (CNT).

FIG. 4A shows cyclic voltammograms of 20 mM cyano-metal solutions (Au, Ag, Cu, and Fe) with carbon paper working and counter electrodes; 20 mV/s scan rate, 10th cycle shown.

FIG. 4B shows PVF-CNT working electrode uptake and release performance for singular 1 mM cyano-metal solutions: KAu(CN)₂, KAg(CN)₂, K₂Cu(CN)₃, and K₃Fe(CN)₆.

FIG. 4C shows uptake and release performance of a quaternary cyano-metal solution (containing 0.25 mM of Au, Ag, Cu, and Fe) over multiple recovery cycles where the same PVF-CNT working electrode was reused; gold selectivity was calculated versus all competing cyano-metals (Ag, Cu, and Fe) in the final desorption solution.

FIG. 4D shows gold x-ray photoelectron spectroscopy (XPS) spectra of a PVF-CNT working electrode and carbon paper counter electrode after electrosorption and after desorption compared to metallic metal controls.

FIG. 5A shows a proposed mechanism of gold (KAu(CN)₂) adsorption via favorable charge transfer binding of the cyano-gold anion and oxidized ferrocenium cationic site for the PVF-CNT electrosorption system.

FIG. 5B shows a gold adsorption isotherm with PVF-CNT working electrode at an applied potential of 0.8 V vs Ag/AgCl for 30 minutes; gold uptake follows the Langmuir adsorption model with R² of 0.997.

FIG. 5C shows gold uptake kinetic data for an applied potential of 0.6 V, 0.8 V, and 1.0 V vs Ag/AgCl and model fit using a Langmuir kinetic model.

FIG. 5D shows a proposed mechanism of gold desorption via electrochemical reduction of ferrocenium to neutral ferrocene, deactivating the binding site and releasing cyano-gold.

FIG. 5E shows, for a situation where [Au(CN)₂] was adsorbed from a 1 mM solution and electrochemically released into a range of solutions already containing [Au(CN)₂]⁻ from 1 mM to 20 mM, that electrochemical gold release is independent of the gold up-concentration ratio ([Au]_{des}/[Au]_{ads}).

FIG. 5F shows electrochemical gold release kinetic data which reveals that 90% of captured gold is released within 5 minutes.

FIG. 6A shows inline inductively coupled plasma—optical emission spectrometry (ICP-OES) derived gold uptake kinetics from a continuously operated flow-by cell for two adsorption (+1.8 V WE-CE) and desorption (−1.8 V WE-CE) cycles.

FIG. 6B show flow cell energy consumption normalized by mass of PVF coating for adsorption and desorption.

FIG. 6C shows a comparison of modeled flow cell gold uptake kinetics to experimental data with Langmuir kinetic model (dashed line).

FIG. 6D shows Langmuir kinetic model (dashed line) of exiting gold concentration from the PVF-CNT flow-by cell compared to experimental data.

FIG. 7A is a schematic diagram of e-waste leaching to gold capture and purification with a PVF-CNT electrosorption system.

FIG. 7B shows estimated overall leaching plus refinement cost compared between PVF-CNT and activated carbon working electrodes for traditional acid treated electronic waste, optimized e-waste cyanide leaching, and cyanide leaching of simulated gold ores.

FIG. 7C shows PVF-CNT electrosorbent gold recovery efficiency and selectivity factor for different leach solutions.

FIG. 7D shows PVF-CNT gold selectivity isotherm for low grade ore, optimized E-waste, and acid treated e-waste. The lines represent three PVF separations in series to purify gold from 10% to 99%.

FIG. 8A shows a comparison of PVF-CNT and activated carbon as adsorbents in a modeled carbon-in-pulp style process, where the gold adsorption isotherms were compared for each adsorbent.

FIG. 8B shows the final achievable purity and resulting gold product value for each adsorbent.

FIG. 8C shows the achievable concentration and resulting gold electrowinning current efficiency value for each adsorbent.

FIG. 8D compares the overall gold recovery cost per mass of gold over a range of gold leach feed concentrations for PVF and activated carbon adsorbents; the upper area of the figure represents the range where the cost of gold recovery is higher than the current value of gold ($60 USD/g).

### DETAILED DESCRIPTION

Described in this disclosure is the application of redox-based metallopolymers for electrochemically-mediated separation and recovery of gold-based complexes from industrial, mining and/or waste fluids. In particular, an electrochemical system and method for recovering and optionally purifying gold from electronic waste and mining streams are described, along with an electrode comprising a redox-active metallopolymer that functions as a gold-selective electrosorbent.

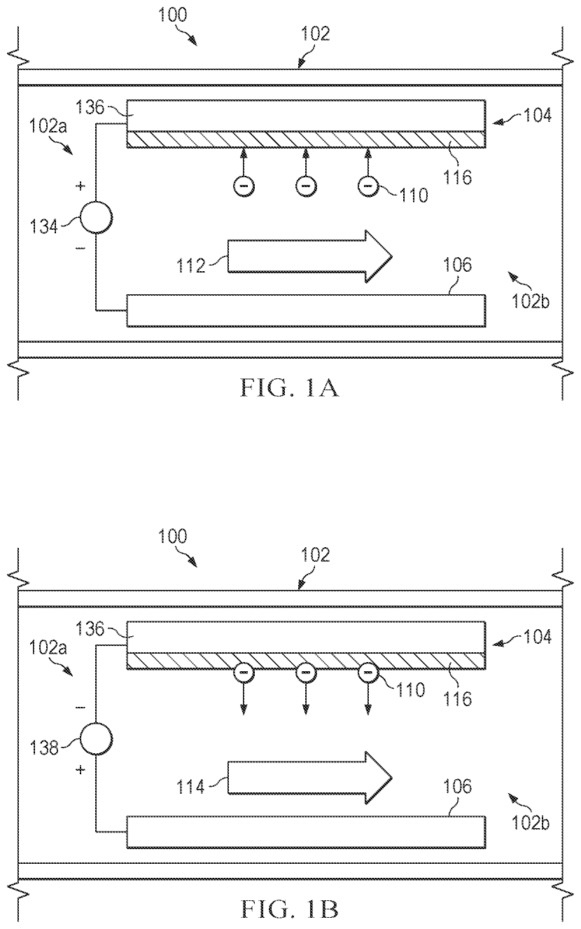

Referring now to FIGS. 1A and 1B, an electrochemical method for recovery of gold from mining and electronic waste streams is described. The electrochemical method includes electrochemically adsorbing gold complexes 110 from a leach solution 112 onto a redox-active metallopolymer 116, as illustrated in FIG. 1A. More specifically, the gold complexes 110 are selectively electrochemically adsorbed onto the redox-active metallopolymer 116 from the leach solution 112. The electrochemical adsorption may be described as selective electrochemical adsorption because the redox-active metallopolymer 116 preferentially adsorbs gold complexes from the leach solution 112, whereas other metal complexes in the leach solution 112, such as silver, iron and/or copper complexes, are not adsorbed in any significant amount or at all. After selective electrosorption, the gold complexes 110 may be electrochemically released from the redox-active metallopolymer 116 into a collection fluid 114, as illustrated in FIG. 1B. Optionally, following the electrochemical release, metallic gold may be electrodeposited onto a conductive substrate from the gold complexes 110 accumulated in the collection fluid 114, allowing for the recovery of purified gold metal, as discussed below.

The leach solution 112 is typically obtained from mining streams or electronic waste streams. Such leach solutions 112 may contain anionic gold species. For example, the gold complexes may comprise dicyanoaurate(I) ([Au(CN)₂]⁻), tetracyanoaurate(III), gold(III)-chloride, gold(III)-iodide, gold(III) bromide, auride (Au⁻), gold(I)-thiomalate, and/or gold(I)-thiosulfate.

The redox-active metallopolymer 116 may be understood to be a polymer including metal atoms and redox-active units that can undergo an electron transfer process to become oxidized or reduced. For example, the redox-active metallopolymer 116 may comprise polyvinylferrocene (PVF), polyferrocenyl silane (PFS), poly(3-ferrocenylpropyl methacrylamide (PFPMAm), poly(2-((1-ferrocenylethyl)(methyl)amino)ethyl methacrylate) (PFEMA), and/or poly(2-(methacryloyloxy)ethyl ferrocenecarboxylate) (PFCMA). The redox-active metallopolymer 116 may form part or all of a coating on a conductive substrate 136 that functions as a working electrode 104 (and/or a counter electrode, as discussed below). A loading level of the redox-active metallopolymer 116 on the conductive substrate 136 may be in a range from about 0.1 mg/cm² to about 1.0 mg/cm². In some examples, the coating may further comprise a carbon-based material, such as carbon nanotubes (CNT), carbon nanofibers, activated carbon, graphite, and/or graphene. As discussed in the examples below, the addition of CNT within the PVF coating may enhance charge transfer, introduce microporosity, and increase surface area, leading to a composite PVF-CNT coating comprising a dense microporous network of electrochemically-mediated adsorption sites.

Referring again to FIG. 1A, selectively electrochemically adsorbing the gold complexes 110 onto the redox-active metallopolymer 116 may be carried out by applying an oxidizing potential 134 to a working electrode 104 including the redox-active metallopolymer 116, thereby oxidizing neutral sites of the redox-active metallopolymer 116 to form cationic sites. During the application of the oxidizing potential 134, the redox-active metallopolymer 116 is exposed to the leach solution 112 comprising the gold complexes 110. Consequently, the gold complexes 110, which comprise anionic gold species, adsorb onto the cationic sites. As indicated above, the adsorption is selective such that other metal (non-gold) complexes remain in the leach solution 112 and can be removed from the electrochemical system 100. In some examples, a suitable oxidizing potential 134 may be in a range from about 0.4 V vs Ag/AgCl to about 1.2 V vs Ag/AgCl. The redox-active metallopolymer 116 may be exposed to a flow of the leach solution 112 in what may be a continuous process. For example, the leach solution 112 may be flowed through an electrochemical cell 102 containing the working electrode 104 at a flow rate in a range from 0.1 mL/min to about 100 mL/min (1 mL/min). The electrochemical adsorption may be effective even with dilute leach solutions, e.g., leach solutions 112 including a concentration of the gold complexes 110 in a range from 1-10 ppm and/or from 0.004 mM to 5 mM.

Referring now to FIG. 1B, electrochemically releasing the gold complexes 110 from the redox-active metallopolymer 116 may be carried out by applying a reducing potential 138 to a working electrode 104 comprising the redox-active metallopolymer 116, thereby reducing the cationic sites of the redox-active metallopolymer 116 to form neutral sites. During the application of the reducing potential 138, the redox-active metallopolymer 116 is exposed to the collection fluid 114. Consequently, the gold complexes 110 are released from the neutral sites into the collection fluid 114. In some examples, a suitable reducing potential 138 may be in a range from −0.4 V vs Ag/AgCl to +0.4 V vs Ag/AgCl. The collection fluid 114 and/or the leach solution 112 may include an electrolyte such as NaCl, NaClO₄ and/or potassium cyanide to ensure or enhance electrical conductivity. The collection fluid 114 is typically water-based. In some examples, prior to the electrochemical release of the gold complexes 110, the collection fluid 114 may include a non-zero concentration of gold species, such that electrochemically releasing the gold complexes 110 into the collection fluid 114 entails increasing the gold concentration of (or “up-concentrating”) the collection fluid 114.

As indicated above, an optional step after the electrochemical release is electrodeposition to produce metallic gold of a high purity (e.g., 98% or higher). This process may be referred to as electrowinning or electroplating. The electrodeposition may be carried out by applying an electric reducing potential to a conductive substrate (which is different from that of the working electrode employed for electrosorption) and exposing the conductive substrate to the collection fluid including the gold complexes, leading to deposition of metallic gold onto the conductive substrate. The energy efficiency of gold electrodeposition may be linked to the gold concentration in the collection fluid, where higher gold concentrations may lead to increased electrodeposition efficiency, as discussed in the examples below. After electrodeposition, the metallic gold may be removed from the conductive substrate, e.g., by scraping off as metallic gold powder.

The above-described electrochemical method, including selective electrochemical adsorption, electrochemical release, and optional electrodeposition (or electrowinning), may be implemented as a batch or continuous flow process. Multiple cycles of electrosorption and/or electrorelease may take place to increase the gold uptake of the redox-active metallopolymer 116 and/or to enhance the gold concentration of the collection fluid 114. The electrochemical method may be carried out in a vessel 102 configured for fluid flow, where the vessel 102 contains a working electrode 104 comprising the redox-active metallopolymer 116 and a counter electrode 106 in the vessel 102 spaced apart from the working electrode 104, as illustrated in FIGS. 1A and 1B. Such an electrochemical system 100 is described in greater detail below.

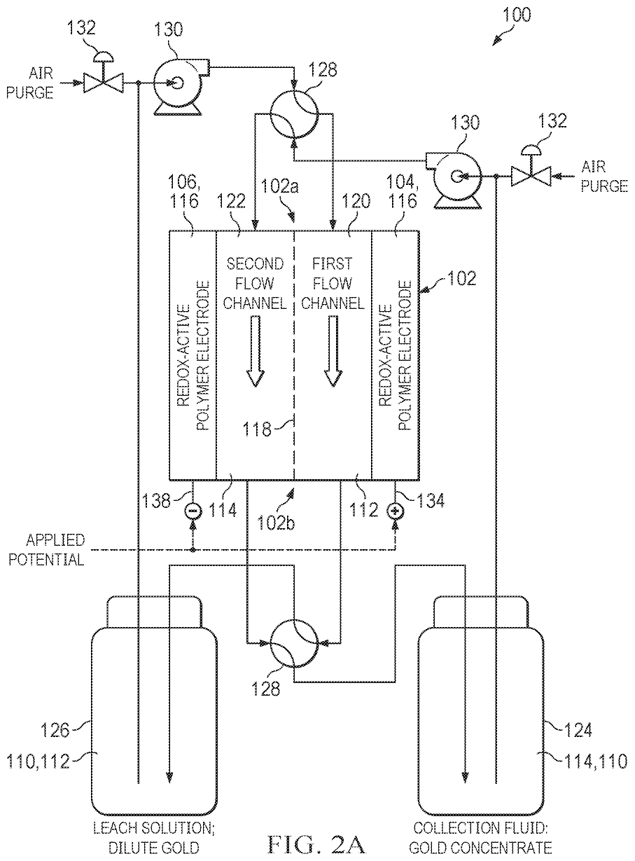

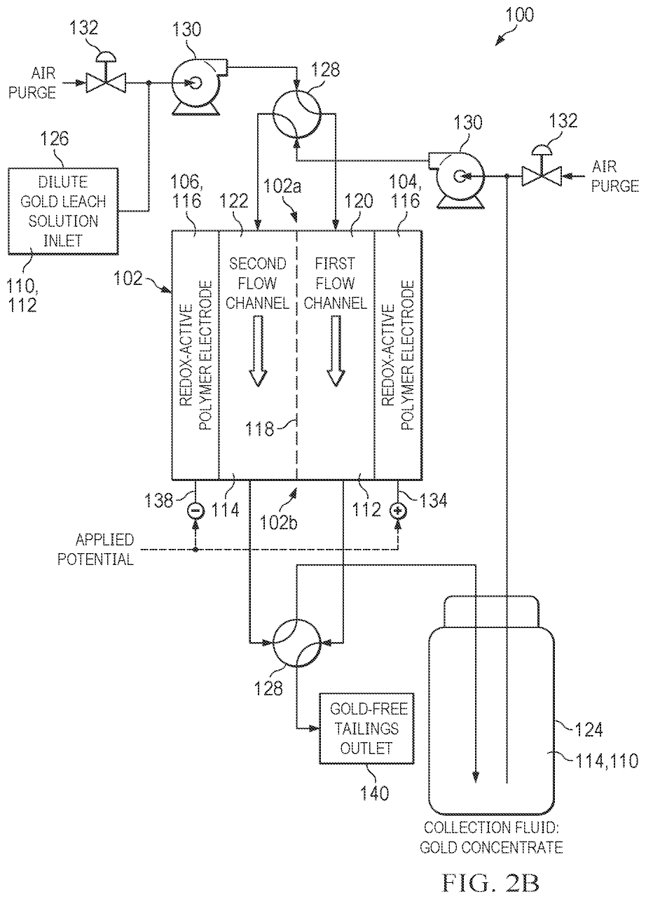

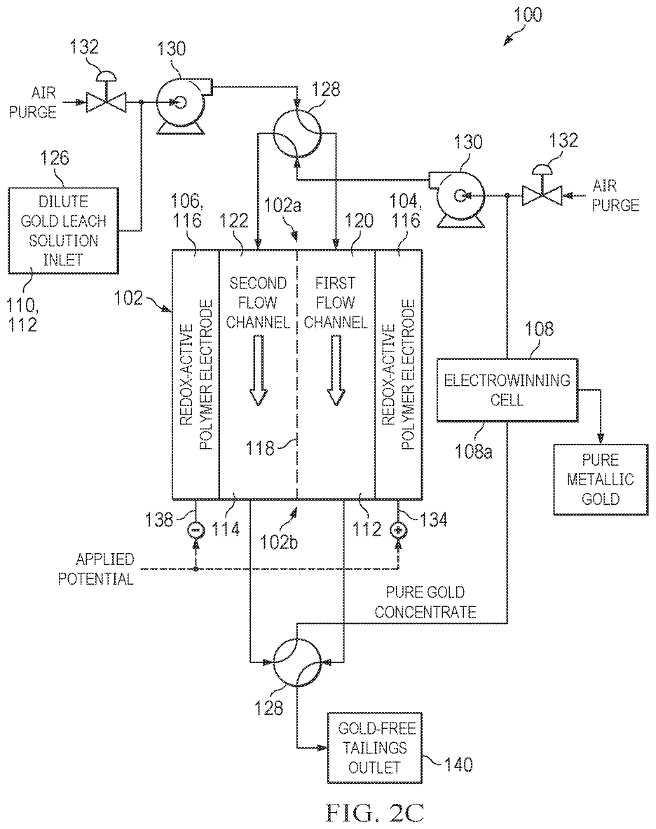

In some examples, as discussed further below in reference to FIGS. 2A-2C, the counter electrode 106 may also comprise the redox-active metallopolymer 116, and the vessel 102 may further include a cation exchange membrane (CEM) 118 between the working and counter electrodes 104,106. The cation exchange membrane 118 separates a first flow channel 120 containing the working electrode 104, which may be referred to as a first electrode, from a second flow channel 122 containing the counter electrode 106, which may be referred to as a second electrode. The cationic exchange membrane 118 is configured to prevent passage of anionic species (e.g., the gold complexes) between the first and second flow channels 120,122.

Accordingly, consistent with FIGS. 2A-2C, the electrochemical method may comprise applying an oxidizing potential 134 to the first electrode 104 and applying a reducing potential 138 to the second electrode 106. During the application of the oxidizing and reducing potentials 134,138, a leach solution 112 may be flowed through the first flow channel 120 and a collection fluid 114 may be flowed through the second flow channel 122. Consequently, gold complexes 110 from the leach solution 112 may be adsorbed onto the redox-active metallopolymer 116 of the first electrode 104, and gold complexes 110 adsorbed onto the redox-active metallopolymer 116 of the second electrode 106 may be released into the collection fluid 114.

The method may also or alternatively entail applying a reducing potential to the first electrode and applying an oxidizing potential to the second electrode. During the application of the reducing and oxidizing potentials, a collection fluid may be flowed through the first flow channel and a leach solution may be flowed through the second flow channel. Consequently, gold complexes from the leach solution may be adsorbed onto the redox-active metallopolymer of the second electrode, and gold complexes adsorbed onto the redox-active metallopolymer of the first electrode may be released into the collection fluid. The method may include multiple cycles of alternating the oxidizing/reducing potentials and the fluid flows through the first and second flow channels, as described above.

As illustrated in FIG. 2A, the leach solution 112 and the collection fluid 114 may be recirculated through the system 100 for use in multiple cycles of electrochemical adsorption and release, where the leach solution 112 becomes devoid of gold complexes 110 and the collection fluid 114 becomes increasingly concentrated with the gold complexes 110. In another example, as illustrated in FIG. 2B, the collection fluid 114 may be recirculated through the system for use in multiple cycles of electrochemical release, while fresh leach solution 112 may be continuously supplied to the vessel 102 for electrochemical adsorption and then removed from the system 100 after adsorption as spent leach solution 140 or “tailings.” Referring to FIG. 2C, the collection fluid 114 may be recirculated through the system 100 in a closed loop, as in FIG. 2B, but in this example, the system 100 may further include an electrowinning cell 108 in the closed loop for electrodeposition of metallic gold from the gold complexes 110 accumulated in the collection fluid 114. As in FIG. 2B, fresh leach solution 112 is continuously supplied to the vessel 102 for electrochemical adsorption and then removed from the system 100 after adsorption as tailings 140.

Now that the electrochemical method has been described according to various examples, an electrochemical system for recovery of gold from mining and electronic waste streams is also described. As shown schematically in FIGS. 1A and 1B, the electrochemical system 100 may include a vessel (or cell) 102 configured for fluid flow, a working electrode 104 positioned in the vessel 102, where the working electrode 104 comprises a redox-active metallopolymer 116, and a counter electrode 106 spaced apart from the working electrode 104 in the vessel 102. The vessel 102 may further optionally include a reference electrode. In some examples, as shown in FIG. 2C, the system 100 may further include an electrowinning cell 108 having an inlet 108a in fluid communication with an outlet 102b of the vessel 102 for electrodeposition of metallic gold from the gold complexes 110 accumulated in the collection fluid 114, as described above. In this disclosure, the phrase “in fluid communication with” means that two components, e.g., the inlet 108a of the electrowinning cell 108 and the outlet 102b of the vessel 102, are connected directly or indirectly (e.g., via pipes, tubing, connectors, pumps, valves, etc.) such that fluid can flow in one or both directions between and/or through the components.

In some embodiments of the electrochemical system, as in shown in FIGS. 2A-2C, both the working electrode 104 and the counter electrode 106 may comprise the redox-active metallopolymer 116, and a cation exchange membrane (CEM) 118 may be included in the vessel 102 between the working and counter electrodes 104, 106. In the following description, the working electrode 104 including the redox-active metallopolymer 116 is referred to as a first electrode, and the counter electrode 106 including the redox-active metallopolymer 116 is referred to as a second electrode. Referring to FIGS. 2A-2C, the CEM 118 separates a first flow channel 120 containing the first electrode 104 from a second flow channel 122 containing the second electrode 106.

The system may include a source 124 of collection fluid 114 in fluid communication with an inlet 102a of the vessel 102. In some examples, as shown in FIGS. 2A-2C, the source 124 of collection fluid 114 may also be in fluid communication with an outlet 102b of the vessel 102, thereby defining a closed loop for recirculation of the collection fluid 114 through the system 100. Accordingly, as the collection fluid 114 passes through the vessel 102 for multiple cycles of electrochemical release, the concentration of gold complexes 110 in the collection fluid 114 can be increased. In some examples, as shown in FIG. 2C, the system 100 may further include an electrowinning cell 108 in the closed loop for electrodeposition of metallic gold onto a conductive substrate from the gold complexes 110 accumulated in the collection fluid 114. After electrodeposition, the collection fluid 114 may be recirculated into the vessel 102 for collection of additional gold complexes 110.

The system 100 may include a source 126 of leach solution 112 in fluid communication with an inlet 102a of the vessel 102. In some examples, as shown in FIG. 2A, the source 126 of leach solution 112 may also be in fluid communication with an oulet 102b of the vessel 102, thereby defining a closed loop for recirculation of the leach solution 112 through the system 100. Accordingly, as the leach solution 112 undergoes multiple cycles through the vessel 102 during electrochemical adsorption, the leach solution 112 can be completely or nearly completely emptied of the gold complexes 110.

The leach solution 112 and the collection fluid 114 may be transported through pipes, tubing, or another type of conduit containing a channel for fluid transport. The system 100 may include one or more valves 128 and one or more pumps 130 for controlling the flow of the leach solution 112 and the collection fluid 114 through the system 100. For example, depending on the position of the (upper) rotary valve 128 shown in FIGS. 2A-2C, the leach solution 112 may be transported through the first or second flow channel 120,122, while the collection fluid 114 is transported through the other flow channel 122,120. The one or more valves 128 may comprise rotary valve(s), check valve(s), and/or other suitable valves. Additional valves 132 may allow for purging of air from fluid channels. The system 100 may further include a power supply electrically connected to the working and counter (or first and second) electrodes 104,106.

In examples where the leach solution 112 includes anionic gold species, the redox-active metallopolymer 116 may comprise polyvinylferrocene (PVF), polyferrocenyl silane (PFS), poly(3-ferrocenylpropyl methacrylamide (PFPMAm), poly(2-((1-ferrocenylethyl)(methyl)amino)ethyl methacrylate) (PFEMA), and/or poly(2-(methacryloyloxy)ethyl ferrocenecarboxylate) (PFCMA). As indicated above, the redox-active metallopolymer 116 may form part or all of a coating on a conductive substrate 136 that functions as a working electrode 104 and/or a counter electrode 106, in some examples. The redox-active metallopolymer 116 may have a loading level on the conductive substrate 136 in a range from about 0.1 mg/cm² to about 1.0 mg/cm². In some examples, the coating may further include a carbon-based material, such as carbon nanotubes (CNT), carbon nanofibers, activated carbon, graphite, and/or graphene. Thus, an electrode 104,106 for recovery of gold from electronic waste and mining streams may include a conductive substrate 136 and a redox-active metallopolymer 116 on the conductive substrate 136, where the redox-active metallopolymer 116 preferably comprises polyvinylferrocene.

### EXAMPLES

In addition to the above-described electrochemical system, method and working electrode, results of an investigation of a particular redox-active metallopolymer (PVF) are discussed.

In this investigation, the binding affinity of PVF to anionic noble-metal complexes is examined for the first time, and the selectivity of a PVF electrosorbent towards dicyanoaurate ([Au(CN)₂]⁻) or “cyano-gold” compared to common competing metal-cyanide ionic complexes (silver, copper, nickel, and iron) is benchmarked. A kinetics study provides insights into the facile electrochemical switching behavior of the PVF-electrosorbent. The electrochemical concentration of gold with PVF in a scaled-up continuous flow system is demonstrated, and the system is deployed to recover and purify gold from local-sourced e-waste and simulated mining ore, to showcase the ease of integration of the inventive system as a drop-in, electrified replacement for activated carbon in a CIP-type process. It is found, as detailed below, that PVF redox-electrodes can capture cyano-gold with 10-fold higher uptake (>200 mg/g) than conventional activated carbon, and importantly, exhibit a separation factor of greater than 20 for gold over competing metals in mining and electronic waste, including silver, copper, nickel, and iron. Rapid gold uptake is observed within 5 minutes, and electrochemically-mediated release and concentration of the cyano-gold can achieve an up-concentration ratio of 20:1. Electrochemical recycling of gold from real-world electronic waste (e.g., RAM boards) is demonstrated with a recovery efficiency of 99% and superior technoeconomics (94% cost reduction, and a 90% increased final gold purity) compared to conventional activated carbon. This investigation reveals that redox-active electrosorption may serve as a resource-efficient means of electrified process intensification for selective gold recycling, up-concentration, and refinement in a single process unit, paving the way for sustainable gold mining and recycling.

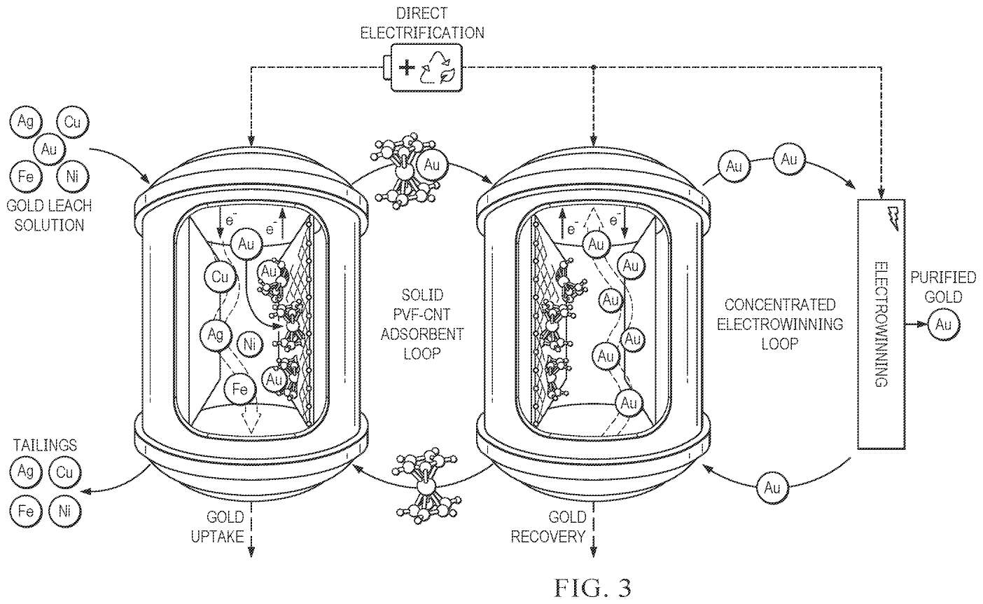

FIG. 3 is a schematic diagram of an exemplary PVF-CNT electrosorption system, where gold complexes from a leach solution are selectively adsorbed to oxidized ferrocene sites of electrode-bound PVF in an adsorption tank, and silver, copper, iron, and nickel complexes exit in a tailings stream. The gold-laden PVF-CNT electrodes are transferred to an elution/regeneration tank where the gold complexes are released into a collection stream, which is delivered to a high concentration gold electrowinning loop. The released gold is then electrodeposited as purified metallic gold. The reduced PVF-CNT electrode is cycled back to the adsorption tank. The whole recovery process consumes only electrical energy to capture, release, and deposit gold.

### Methods

PVF-CNT electrode preparation. PVF-functionalized electrodes were prepared by a dip-coating method using 50 μL of PVF-CNT solution. Equimolar poly(vinyl)ferrocene and carbon nanotube (PVF-CNT) composites were coated in 1−1 cm² on the carbon paper. Cyclic voltammetry data clearly showed oxidation and reduction peaks of PVF at 600 mV and 100 mV to confirm the redox-behavior of the ferrocene-units.

Electrochemical adsorption. The Au uptake experiments were conducted in a three-electrode system with a PVF-CNT working electrode, carbon paper counter electrode, and an aqueous Ag/AgCl (3M NaCl) reference electrode. All uptake experiments were carried out for 20 minutes with 1.3 mL of Au-involved mixture and 20 mM NaClO₄ for adsorption and desorption, respectively. For all electrosorption tests, the sum of cyano-metal concentrations was fixed to 1 mM; for instance, in binary solution, 0.5 mM of KAu(CN)₂ was mixed with 0.5 mM of KAg(CN)₂, K₂Cu(CN)₃, or K₃Fe(CN)₆, while 0.25 mM of all cyano-metals (Au, Ag, Cu, Fe) in the quaternary mixture. Then the uptake of cyano-metals was analyzed using inductively coupled plasma optical emission spectrometry (ICP-OES).

Electrochemical analysis. Cyclic voltammetry was conducted to investigate the characteristic electrochemical properties of cyano-metal contents. The experiments were conducted in a three-electrode system with carbon paper as both working and counter electrodes and Ag/AgCl (3M NaCl) as a reference electrode at a scan rate of 20 mV/s. Then the electrochemical reactivity of PVF-CNT with Au was demonstrated in two different Au solutions at a scan rate of 10 mV/s.

Flow cell operation. Continuous electrochemical uptake and release of 1 mM KAu(CN)₂ with 20 mM NaClO₄ supporting electrolyte was performed in a 4 cm×4 cm flow-by cell with an internal liquid volume of 1 mL. The Toray 030 carbon paper working electrode was coated with 4 mg PVF from PVF-CNT ink solution (same used in batch experiments) and pressed against a titanium current collector. Similarly, the counter electrode was bare Toray 030 carbon paper pressed against a titanium current collector. Gold solution flowed through the flow-by cell at 1 mL/min with a peristaltic pump. The gold concentration exiting the flow-by cell was monitored with inline ICP-OES analysis. The two-electrode flow-by cell was electrochemically controlled via a potentiostat and operated with constant applied potential.

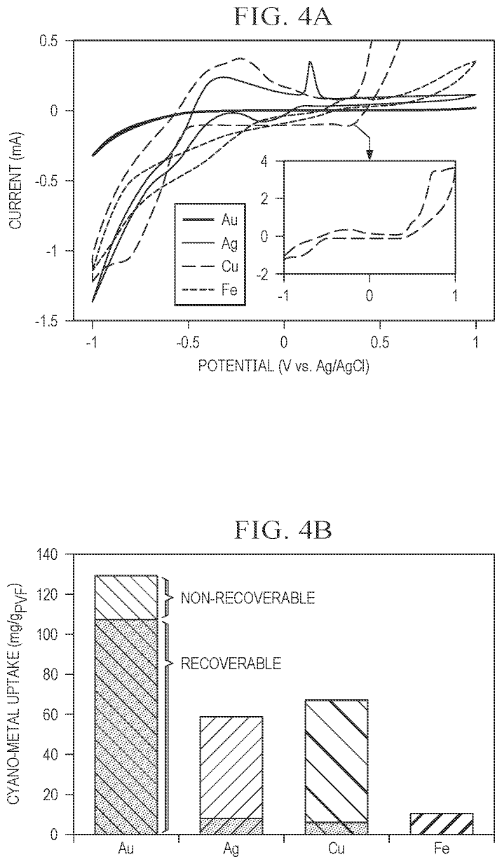

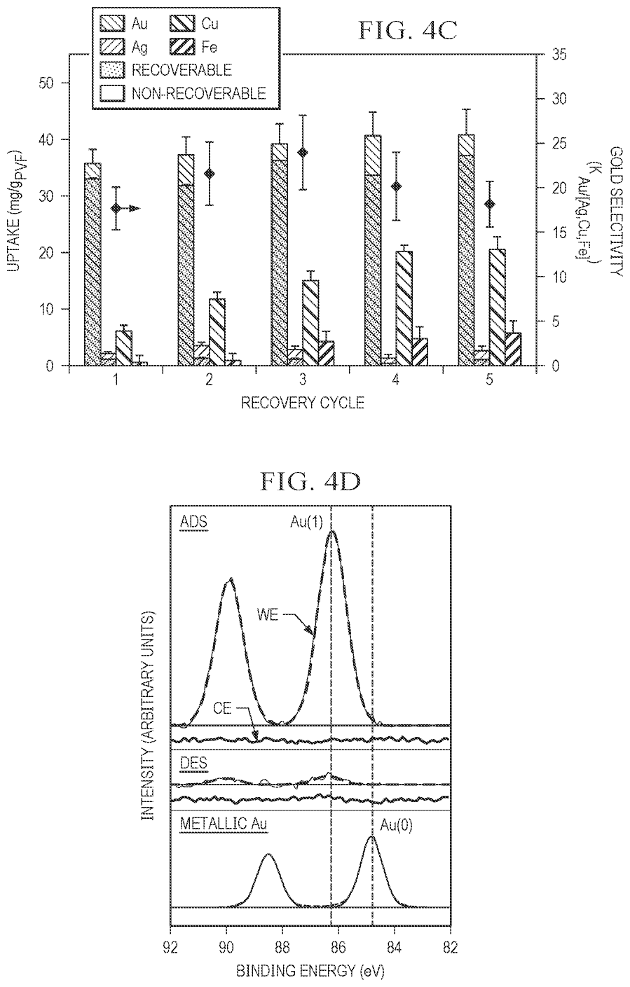

Kinetics modeling. PVF-enabled electrochemical cyano-gold adsorption kinetics were modeled with a 2nd order polynomial rate expression derived from the reversible elementary reaction governing Langmuir adsorption. First Langmuir adsorption equilibrium parameters were estimated from experimental gold adsorption data over a range of equilibrium gold concentrations (FIG. 4A). The Langmuir adsorption isotherm model fits experimental data with R2=0.997. With estimated equilibrium parameters qₘₐₓ and K_{eq}, the Langmuir kinetic model was fit to experimental kinetic data to estimate the forward rate constant of [Au(CN)₂]⁻ adsorption to surface-bound ferrocene sites. For batch scale data, the reactor was assumed to be perfectly mixed, and the volume change from aliquots (50 μL each aliquot) was considered in the system mass balance. For flow cell data, the reactor was again assumed perfectly mixed in the direction perpendicular to fluid flow due to close electrode spacing of 0.2 mm with a Teflon baffle to increase turbulence.

$${r}_{{θ}_{A u}} = {k}_{a d s} * ( {[ A u ]}_{0} - {θ}_{A u} \frac{{m}_{F c} * {q}_{ma x}}{V} ) * ( 1 - {θ}_{A u} ) - \frac{{k}_{a d s}}{K} * {θ}_{A u} \qquad ( eq . 1 )$$

E-waste recycling and cyanidation process. Gold leach solutions were produced in-house from scrap electronic waste DDR2 RAM boards which contained roughly 1 mg gold per gram of E-waste, as measured from ICP-OES. Two approaches were taken to produce gold leach solutions from E-waste: a traditional E-waste recycling approach and a PVF-CNT optimized approach. For the traditional approach, the gold contacts of RAM chips were removed (200 g) and added to 400 mL of 38% HCl solution to leach all the copper. 400 mL of 3% hydrogen peroxide was progressively mixed in and stirred over 8 hours. The gold contacts were filtered from the solution, large pieces of the remaining circuit board removed, and washed with 2L of water. The dried gold contacts were added to a 600 mL leach solution of 20 mM KCN and 1 mM KOH, and the air was bubbled into the stirred vessel for 24 hours to leach the gold. Following cyanidation, the solution was neutralized to a pH of 7.0 with 7 mL of 1M HClO₄. Due to the risk of releasing hydrogen cyanide during neutralization, the cyanidation vessel was vented to a bubble trap filled with 1M KOH to recapture cyanide.

Gold cyanidation of electronic waste was optimized for selective PVF-CNT capture and up-concentration with the following approach. 150 g of uncut, as-received Samsung RAM modules were placed directly into 500 mL of 10 mM KCN leach solution, and the gold cyanidation vessel was bubbled with air and stirred for 24 hours. Following gold cyanidation, the leach solution was neutralized with 2.5 mL of 1M HClO₄.

Lastly, simulated leach solutions from gold mining were prepared from 11.4 mg/l of metallic gold, 4.9 mg/l of metallic silver, 24 mg/l of metallic copper, and 45 mg/l of metallic iron similarly to previous cyanidation experiments. The 500 ml leach solution contained 5 mM KCN and after 48 hours of cyanidation, the leach solution was neutralized with 1.5 mL of 1M HClO₄.

Techno-economic analysis. The PVF-CNT electrosorption strategy described in this disclosure was compared to activated carbon (AC) in the traditional carbon-in-pulp process, with gold adsorption occurring in a multi-stage counter-current adsorption cascade for both strategies (electrochemical and non-electrochemical). Gold release (or elution) and adsorbent regeneration steps were modeled from the electrochemical experiments for PVF, and modeled after the Zadra elution process for activated carbon. The basis for this techno-economic analysis was a gold mine with a pulp feed rate of 250,000 tons per month, 45% solids, with a gold grade of 1.5 g/tonne.

### Results

Characterization of PVF-CNT electrodes. Selective gold capture and up-concentration was achieved through robust and reusable polyvinyl ferrocene and multi-walled carbon nanotube (PVF-CNT) coated electrodes. PVF-CNT electrodes were fabricated by a drop-casting method on carbon paper (CP), and the bare CP was used as a counter electrode due to its electrochemical stability and unfavorable surface for electrodeposition of anionic species such as gold, silver, and copper cyano-metals (FIG. 4A). The addition of CNT within the PVF coating has been found to enhance charge transfer of the ferrocene redox centers while also introducing microporosity and increased surface area, as seen with SEM. The combined PVF-CNT coating enabled a dense microporous network of electrochemically mediated heterogeneous adsorption sites with oxidation and reduction of 0.2 mg/cm² electrode-bound PVF occurring within 2 minutes. EDS mapping of PVF-CNT coated CP electrodes indicated an abundance of well-distributed iron within the coating, confirming even immobilization of ferrocene sites on the surface of the electrode. Lastly, 90% retention of the redox activity was observed after 3,000 consecutive charge-discharge cycles under 20 mM background electrolyte (20 mM NaClO₄), indicating that the PVF-CNT coated electrodes are capable of considerable reuse.

Cyano-metal electrochemistry. Aqueous cyano-metals exhibit various redox behaviors such as electrodeposition, reduction, oxidation, precipitation, and electro-stripping depending on the metal, cyanide concentration, pH, and applied electrical potential. Therefore, the electrochemical characteristics of 20 mM cyano-metal solutions (Au, Ag, Cu, Fe) were investigated with cyclic voltammetry using carbon paper electrodes (FIG. 4A). Between the potential window of −1.0 V and +1.0 V vs Ag/AgCl, no electrochemical reactivity was observed for potassium dicyanoaurate on carbon paper despite the formal reduction potential of dicyanoaurate being −0.8 V vs Ag/AgCl due to the unfavorable deposition surface of carbon paper which has been shown in literature to push the overpotential of cyano-gold deposition to less than −1.1 V vs Ag/AgCl. In addition, no change in gold concentration was observed with ICP-OES, in a system utilizing carbon paper as working electrode. Silver cyanide (potassium dicyanoargentate) and copper cyanide (potassium tricyanocuperate) exhibited clear electrochemical deposition and stripping, where deposition of silver occurred at −0.5 V vs Ag/AgCl and silver stripping occurred at +0.2 V vs Ag/AgCl. For copper cyanide, electrodeposition occurred at −0.6 V vs Ag/AgCl and electro-stripping occurred at +0.8 V. Cyclic voltammetry of 20 mM ferricyanide showed a reversible one-electron transfer reaction at +0.2 V vs Ag/AgCl. In summary, cyano-metal electrochemical characteristics exhibit that the gold cyanide can be electrochemically adsorbed and desorbed within the operating voltage of −1.0 V and 1.0 V without any irreversible electrodeposition and stripping.

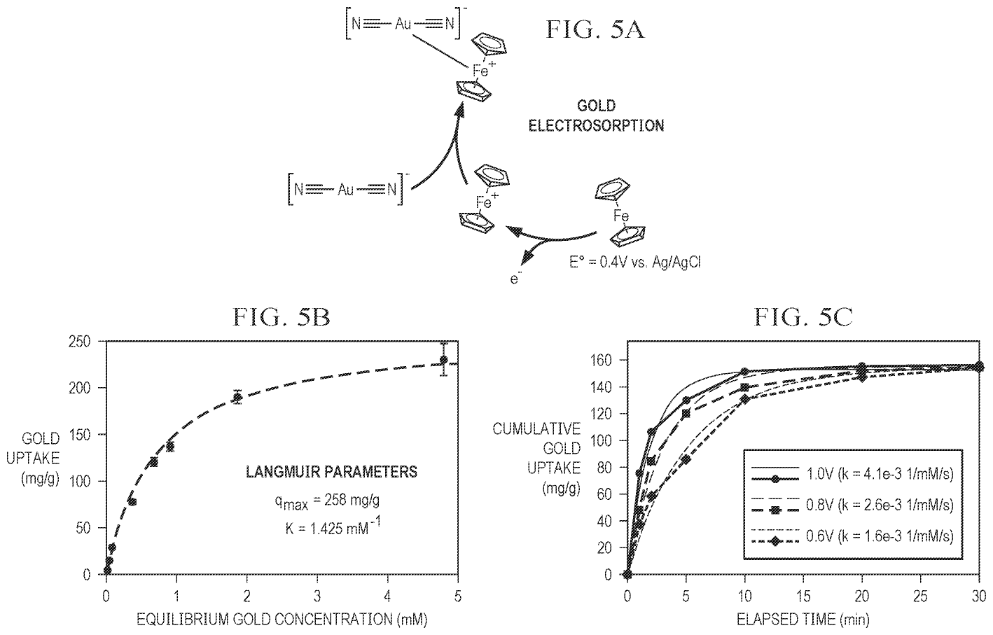

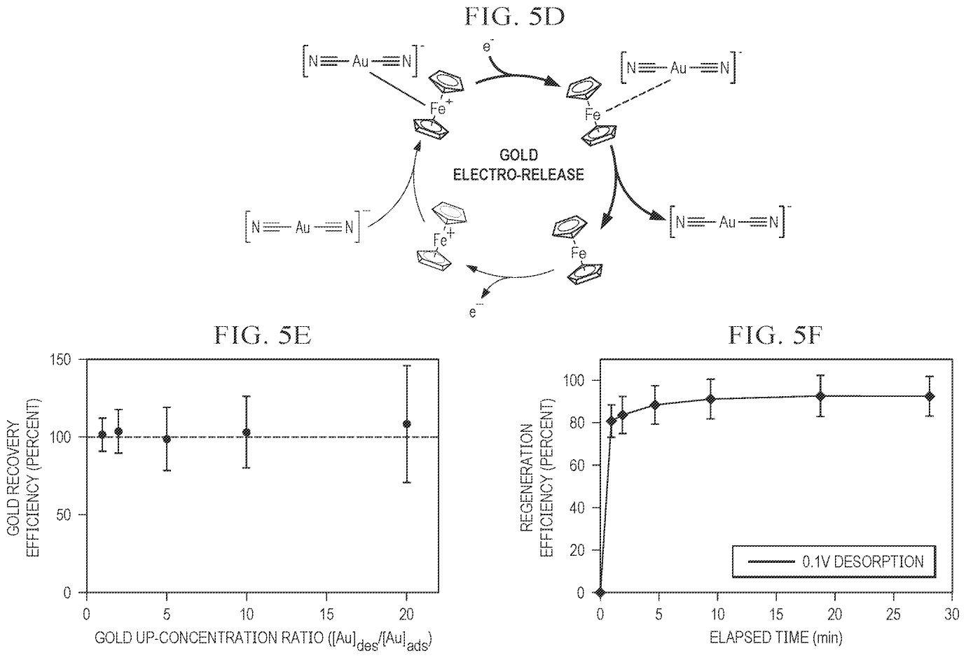

Electrochemical gold capture and recovery. Electrosorption of a target cyano-metal was initiated via electrochemical oxidation of neutrally charged polyvinyl ferrocene (PVF) to the cationic form, ferrocenium (FIGS. 3 and 5A). Cyclic voltammetry of PVF-CNT electrodes in a solution of 20 mM KAu(CN)₂ resulted in an observable redox peak shift from 0.40 V to 0.36 V vs Ag/AgCl compared to NaClO₄ solution, indicating more energetically favorable binding of cyano-gold anions to cationic ferrocenium sites compared to perchlorate anions. Compared to NaClO₄ as supporting electrolyte, the voltammogram of PVF with only KAu(CN)₂ as supporting electrolyte displayed broader peaks and a decreased peak current, indicating that the kinetics of PVF redox is highly dependent of the counterion diffusion rate, and diffusion of the dicyanoaurate anion is slower than perchlorate. Additionally, the PVF voltammogram remained stable for over 20 cycles, confirming that ferrocenium-[Au(CN)₂]⁻ binding is a fully reversible process, with readily release of the bound gold complexes from the electrode-bound ferrocene through a reduction process. Furthermore, the PVF-CNT electrode could be reused to capture and release [Au(CN)₂]⁻ over again for multiple cycles (FIG. 4C).

Electrosorption experiments were conducted at a constant applied potential, where the gold concentration in the liquid phase was monitored via ICP-OES throughout adsorption. FIG. 5C showed the resulting adsorption kinetics of cyano-gold at an applied potential of 0.6 V, 0.8 V, and 1.0 V vs Ag/AgCl. Gold uptake (defined as mg-Au/g-PVF) rapidly converged to an equilibrium uptake of 159 mg/g within 30 minutes above an applied potential of 0.4 V. Near the standard potential of PVF, 0.4 V vs Ag/AgCl, no appreciable uptake was observed due to a lack of adequate driving potential to fully oxidize ferrocene sites. Energy consumption per mass of PVF was calculated for each applied potential from chronoamperometric data, and at a potential of 0.6 V vs Ag/AgCl, energy consumption was 39% less than at 1.0 V (1.80 KJ/g-_{PVF} for 0.6 V; 2.99 KJ/g-_{PVF} for 1.0 V). On the basis of energy consumption per mass of gold adsorbed, a local minimum was observed at 0.6 V vs Ag/AgCl (15.9 KJ/g-_{Au}) indicating a balance of gold uptake and energy efficiency, and thus electrosorption at +0.6 V vs Ag/AgCl was selected as the optimal applied potential for all further separation experiments unless otherwise noted.

After electrosorption, gold was only observed near Fe sites on the PVF-CNT electrode with SEM-EDS, and no appreciable gold was observed on the counter electrode. XPS analysis of the working and counter electrodes was used to observe the speciation of gold via analysis of the Au 4f spectra region. Potassium dicyanoaurate exhibited a peak of 86 eV, correctly correlating to Au(I) speciation in literature, and electrodeposited gold (−1.5 V vs Ag/AgCl for 30 minutes) exhibited a peak at 84.0 eV confirming metallic Au(0) speciation from literature as well (FIG. 4D). Only Au(I) speciation was observed on the PVF-CNT working electrode after electrosorption of 1 mM [Au(CN)₂]⁻, and no gold was detected with XPS on the counter electrode from the same experiment. Therefore this combined spectroscopic evidence suggested that [Au(CN)₂]⁻ anions from solution were electrochemically captured to electrode-bound ferrocene sites without alteration of the oxidation state of the Au(I) molecule and without any electrodeposition onto the working or counter electrodes, proving the redox-mediated electrosorption mechanism for the process driven by previous observations of Fc-mediated binding in noble metal catalyst recovery.

For mining of low-grade gold ores and electronic waste recycling, soluble cyano-gold is typically ultra-dilute in concentration (1-10 ppm), therefore to investigate industrial applicability, KAu(CN)₂ adsorption at ultra-dilute concentrations with PVF-CNT electrodes was executed over a range of cyano-gold concentrations (0.004 mM to 5 mM Au(CN)₂). The resulting gold electrosorption isotherm (FIG. 3b) was well captured with a Langmuir isotherm model (R² of 0.997), and the following Langmuir parameters were estimated: qₘₐₓ=258 gm/g and K=1.425 mM⁻¹. The Langmuir isotherm model suggests a finite number of binding sites supporting the F_{C}_{⁺} site-based adsorption mechanism outlined in FIG. 5A. Remarkably, gold electrosorption remained quite effective down to a 0.004 mM gold solution, with a 51.4% recovery efficiency of the gold from the solution. The energy consumption of adsorption remained constant regardless of gold concentration, with an average energy consumption of 2.88 KJ/g-_{PVF}. The observed decoupling of gold concentration from energy consumption with the PVF-CNT adsorption system further supported that [Au(CN)₂]⁻ ions remained inert (non-electroactive) during the process of electrosorption.

The electrosorption kinetics profiles for 0.6 V, 0.8 V, and 1.0 V vs Ag/AgCl, shown in FIG. 5C, were fit to a Langmuir adsorption kinetics model (Equation 1) with qₘₐₓ and K from equilibrium data, and the observed forward rate constant of adsorption was estimated for each applied adsorption potential. The average forward rate constant was 2.8e-3 L mmol⁻¹ s⁻¹. The Langmuir kinetic model is polynomial in order, but simplifies to a pseudo 1st order kinetic model when the system contains more target adsorbate molecules than can be bound to the adsorbent. For the gold adsorption kinetic experiments, the initial amount of gold in solution was set to a 5:1 excess with electrode-bound ferrocene adsorption sites, and as expected, a pseudo 1st order Langmuir kinetic model captured the kinetics of the gold electrosorption data well with R²=0.992, indicating that gold electrosorption with PVF electrosorbent well captured by Langmuir adsorption theory for both equilibrium and kinetics. The forward rate constant of gold adsorption with PVF electrodes was observed to be linearly dependent with applied potential above the standard potential PVF with a rate of 6.25e-3 L mmol⁻¹ s⁻¹ V⁻¹, however the equilibrium gold uptake approached 158 mg/g regardless of applied overpotential (FIG. 5C), indicating that the number of electrochemically generated ferrocenium adsorption sites was similar for 0.6 V, 0.8 V, and 1.0 V. Therefore, higher applied overpotentials likely facilitate faster ion transport of the target gold anion to the electrode surface. The potential at the carbon paper counter electrode for all experiments rapidly approached a steady state value of −0.8 V vs Ag/AgCl in, and the counter electrode reaction was likely hydrogen evolution as no gold was observed on the counter electrodes with XPS (FIG. 4D).

Electrochemical gold release and up-concentration. The release of captured Au(I) from electrode-bound F_{C}_{⁺} sites was accomplished through electrochemical reduction of F_{C}_{⁺} to neutral Fc at a reducing potential (FIG. 5D). Full reduction of PVF-CNT electrodes was shown to occur below the potential of 0.4 V vs Ag/AgCl, while gold electrodeposition was determined to occur at less than −1.1 V vs Ag/AgCl (FIG. 4A). Therefore, a range of potentials from −1.0 V to +0.3 V vs Ag/AgCl was deemed adequate for gold desorption, and a PVF reduction potential of +0.1 V vs Ag/AgCl was chosen as the standard desorption potential to minimize energy consumption and mitigate unwanted side reactions. After adsorption of [Au(CN)₂]⁻ from a 1 mM solution with an average uptake of 132 mg/g, the captured cyano-gold was electrochemically released (+0.1 V vs Ag/AgCl for 30 minutes) into a new electrolyte solution where 90% of adsorbed cyano-gold was recovered into a gold-free 20 mM NaClO₄ solution, and release kinetics, shown in FIG. 5F, indicated rapid gold release occurred within 5 minutes. Cyano-gold release was observed to be kinetically faster than adsorption and did not correlate with the Langmuir kinetic model as the gold release was driven by rapid electrochemical deactivation of adsorption sites rather than adsorbate concentration.

The ability to separate gold from a dilute stream and concentrate it into a value-added stream is of great industrial importance, and the key to metal purification in mining and recycling pathways. To demonstrate this capability through selective electrosorption, cyano-gold was electrochemically captured from a 1 mM KAu(CN)₂ solution and released into gold-containing solutions of higher concentrations (1, 2, 5, 10, and 20 mM Au(CN)₂). Remarkably, the electrochemical release of gold cyanide was observed independent of gold concentration in the desorption solution, with an average regeneration efficiency of 100% (FIG. 5E). It should be noted that the measurement of the change in gold concentration after desorption was increasingly difficult to measure with ICP as the initial gold concentration of desorption solution increased, resulting in large error despite 20 replicates. was in This result highlights the reversible nature of the interactions between the gold cyano-complexes and the activated/deactivated ferrocene moieties. PVF-CNT-based gold recovery was proven capable of up-concentrating [Au(CN)₂]⁻ to a concentration of 20 mM (regeneration efficiency of unity), and gold up-concentration will likely remain possible without loss of release performance in gold solutions well over 20 mM due to the independence of gold release performance on the initial desorption solution concentration observed in FIG. 5E. Further, gold regeneration efficiency was shown to be independent of the initial gold concentration of adsorption solution as well (from 7 to 0.006 mM KAu(CN)₂). Therefore, electrochemical gold release of the PVF-CNT system was complete (regeneration efficiency of unity) regardless of the initial gold concentration during adsorption and desorption enabling efficient capture of gold down to 0.006 mM Au in the solution, and subsequent up-concentration of gold to 20 mM Au and achieving an up-concentration ratio of over 3,000 (defined as the ratio of the gold concentration in the desorption solution to adsorption solution).

Competing cyano-metals. Competing metals that most ubiquitously from aqueous cyano-metal complexes alongside gold in both mining streams and e-waste processing (Ag, Cu, and Fe) were investigated individually in single-metal adsorption and desorption experiments to systematically determine the binding affinity of each metal complex with the PVF-CNT system. Irreversible silver and copper removal (15.5% Au and 10.2% Cu regeneration) from the solution was observed following an applied potential of 0.6 V vs Ag/AgCl to a PVF-CNT working electrode for 20 minutes (FIG. 4B), indicating electrodeposition was likely the mechanism of silver and copper removal. This was confirmed with XPS analysis of the working and counter electrodes from corresponding single-metal experiments where only metallic Ag(0) (Ag 3d peak @ 368.2 eV) and Cu(0) (Cu 2p @ 933 eV) were observed on only the counter electrode. Following adsorption, no Ag was observed with XPS on the PVF-CNT working electrode, indicating that electrochemical removal of Ag was not PVF-adsorption based. In the absence of a PVF coating on the working electrode (CNT only control), adsorption of Ag and Cu resulted in high metal uptake, confirming that Ag and Cu removal from respective solutions originated from the electrodeposition onto the counter electrode, not from PVF-adsorption. Ferricyanide is a well-known, stable redox couple with a standard potential of 0.16 V vs Ag/AgCl, and in its oxidized Fe(III) state, ferricyanide was not expected to interact with the oxidation of ferrocene on the working electrode. However, the steady state potential on the carbon paper counter electrode was 0.1 V vs Ag/AgCl, indicating ferricyanide reduction was likely occurring on the counter electrode. Adsorption experiments of 1 mM ferricyanide solution yielded no appreciable iron removal from the solution with or without the presence of PVF (uptake of 10.9 mg/g PVF-CNT, 5.1 mg/g CNT) (FIG. 5A). From single cyano-metal adsorption and desorption experiments, no PVF-based adsorption was observed for Ag, Cu, or Fe; therefore, selectivity was maintained solely for gold cyanide.

Gold recovery from multicomponent solution. Direct gold uptake selectivity was determined via PVF-CNT adsorption and desorption in binary cyano-metal solutions, containing 0.5 mM Au and 0.5 mM of a competing cyano-metal (Ag, Cu, or Fe). For all binary matrices investigated (Au—Ag, Au—Cu, and Au—Fe), the average cyano-gold uptake was 49±7 mg-Au/g and 97.4±2% of gold adsorbed was reversibly released electrochemically with PVF-CNT electrodes. As observed in pure cyano-silver recovery experiments, 29.5 mg-Ag/g of silver was irreversibly removed from the binary Au—Ag solution with a silver recovery efficiency of 11%. For gold-silver matrix recovery, PVF-CNT electrosorption was highly selective to [Au(CN)₂]⁻ anions with a relative selectivity factor of 5.0 Au:Ag, and the gold purity of the solution increased from 65% Au to 90% Au by weight in a single recovery pass. Cyano-copper was observed to irreversibly electrodeposit with the uptake of 6.42 mg-_{Cu}/g and showed no hindrance to reversible gold capture and release with a relative selectivity factor of 45.1 against Cu. In the Au—Cu matrix, gold purity increased from 75% to 99.4%. Virtually no cyano-iron complex was removed from the binary Au—Fe solution with an uptake of 1.8 mg-Fe/g, and only 33% of adsorbed iron was released. For the Au—Fe binary solution, a gold selectivity factor of 17.9 was estimated and the final gold purity was 98.8%. To summarize, cyano-gold capture and release were unaffected by the addition of competing cyano-metals and the results indicate that only gold is selectively bound to ferrocene sites. Previous studies suggest the mechanism of selective adsorption with PVF originates from favorable charge-transfer interaction between target heavy metal anion and ferrocenium binding site which minimizes binding energy, and these proof-of-concept results agree with this hypothesis, showing preferential binding of the dicyanoaurate anion to oxidized ferrocene over other cyano-metals.

Selective capture and recovery of gold from a quaternary solution consisting of 0.25 mM KAu(CN)₂, 0.25 mM KAg(CN)₂, 0.25 mM KCu(CN)₃, and 0.25 mM K₃Fe(CN)₆ in an aqueous solution with 20 mM NaClO₄ as supporting electrolyte was carried out over multiple captures and release cycles (FIG. 5C). After an applied potential of +0.6 V vs Ag/AgCl for 30 minutes to oxidize electrode-bound PVF adsorption sites an average gold uptake of 38.8±2.0 mg-Au/g over 5 consecutive capture and release cycles. Electrochemical gold release to a pristine solution was initiated with a constant applied potential of +0.1 V over 30 minutes to reduce and deactivate ferrocene binding sites, and the resulting gold recovery efficiency averaged 91±4% over all 5 cycles, indicating consistent and successful gold capture and recovery with PVF-CNT coated electrodes over multiple reuse cycles.

The uptake of cyano-silver complexes in the quaternary matrix was very low compared to gold with an average uptake of 2.5±0.8 mg-Ag/g, and silver recovery efficiency of 43.8±6.7% indicating the majority of silver was irreversibly deposited onto the counter electrode. Cyano-copper showed a progressive increase in irreversible uptake with the uptake of 6.1 mg-Cu/g after cycle 1 and 20.6 mg-Cu/g after cycle 5. The mode of copper removal was likely electrodeposition, where deposited copper on the counter electrode from previous cycles catalytically reduced the copper electrodeposition overpotential of consequent cycles, leading to a steadily increased copper uptake per cycle. Further confirming electrodeposition as the key mode of copper removal from quaternary solution, very little copper was released with an average recovery efficiency of 5.9±2.9%. Lastly, iron showed a typically low uptake of 3.3±2.1 mg-Fe/g with PVF-CNT electrodes in the quaternary matrix with an average recovery efficiency of 46.9±41.5%. From the results of FIG. 5C, the PVF-CNT electrosorption system shows remarkable selectivity toward gold with an average selectivity factor of 20.3±2.3 relative to silver, copper, and iron combined (Au:(Ag+Cu+Fe)). Through the PVF electro-recovery, a gold purity of 92.5±0.7% is achieved in the released stream from the cyano-metal mixture (gold purity of 46.4% in the feed stream), clearly promoting the selective gold recovery performance of the system in a range of cyano-metals common to gold mining and electronic waste recycling.

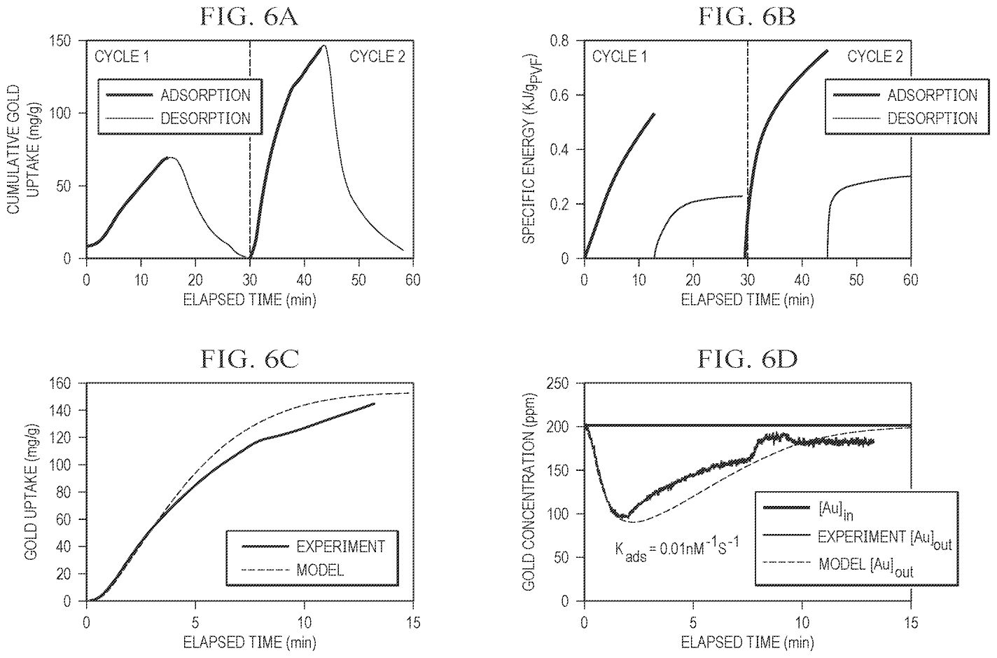

Flow-cell for electrochemical gold recovery. The PVF-mediated gold electro-recovery system was scaled up to a continuous flow by cell with PVF-CNT coated onto a 4 cm by 4 cm titanium working electrode, and a bare titanium counter electrode of equal area. For gold electrosorption, the 2-electrode cell was operated at a constant overall potential of 1.5 V and was determined from the average overall potential of typical 3-electrode batch scale experiments. An aqueous solution containing 1 mM KAu(CN)₂ with 20 mM NaClO₄ as a supporting electrolyte flowed through the flow-by cell at 1 mL/min via a peristaltic pump, and a gold uptake of 77 mg/g was obtained after 15 minutes on the first cycle and uptake of 145 mg/g on the second consecutive flow cycle (FIG. 6A). Electrochemical release of the PVF-adsorbed cyano-gold complex began with a sudden reversal of the overall potential to −1.5 V, and 99.9% of gold was recovered after 15 minutes on cycle 1 and 97.2% on the second adsorption/release cycle. The reason for the near doubling of gold uptake performance on the second absorption cycle was attributed to solvation priming of the pristine PVF-CNT electrode, where the influx of solvated counter ions penetrated and expanded the microporous PVF-CNT coating during initial adsorption exposing previously inaccessible ferrocene sites. The energy of adsorption, calculated from chronoamperometric data, was 0.53 KJ/g-_{PVF} for the first cycle and 0.76 KJ/g-_{PVF} for the Second Cycle (FIG. 6B), Indicating More Ferrocene sites were oxidized on the second cycle. Additionally, the energy per gold adsorbed decreased from 11.0 KJ/g-_{Au} on cycle 1 to 7.4 KJ/g-_{Au} on cycle 2, indicating that less of an overpotential was required to oxidize ferrocene due to enhanced ferrocene site accessibility from cycle 1 priming. Lastly, the forward rate constant of gold adsorption in a flow-by cell was estimated to be 0.01 mM⁻¹s⁻¹ with the Langmuir kinetic model using batch scale equilibrium parameters (qₘₐₓ=258 mg/g and K_{eq}=1.425 mM−1). The Langmur kinetic model fit flow-by cell uptake data with R²=0.952 (FIG. 6C), and deviations from the model were likely from imperfect mixing within the flow-by cell. Modeled gold concentration exiting the flow cell versus time (FIG. 6D) captured the profile of experimental data well, estimating the same minima of exiting gold concentration of 93 mg/L after 2 minutes. The observed adsorption rate constant estimated from flow data agreed with batch results, confirming a similar PVF-enabled redox-mediated adsorption mechanism. The flow-by cell results clearly illustrate the ease of scalability of the PVF electrosorption system for gold recovery and purification, where gold uptake, recovery, energy consumption, and adsorption kinetics were comparable to analytical batch results.

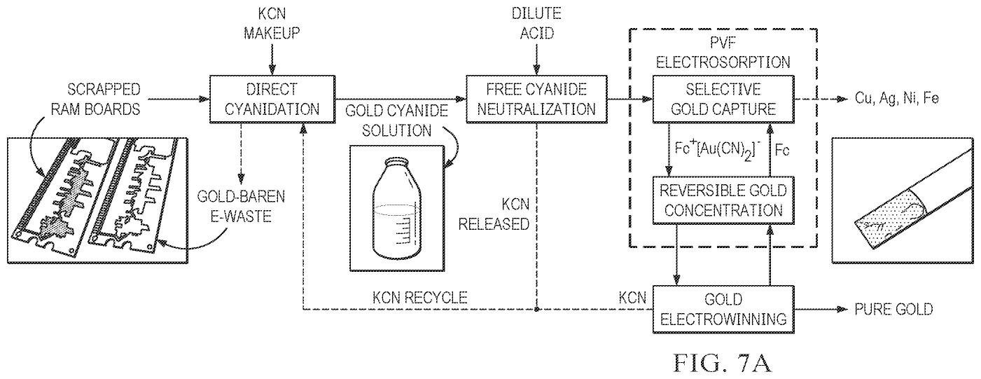

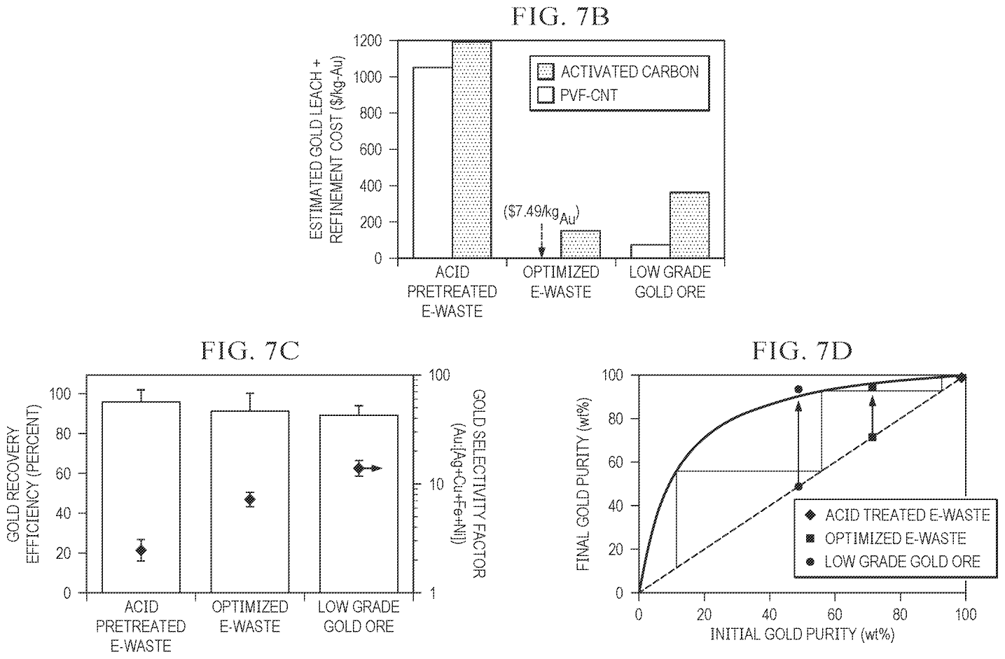

Gold recycling using mining and e-waste streams. A general simulated gold mining leach solution was produced via cyanidation of metallic gold, silver, copper, and iron with 10 mM KCN and bubbled air for 24 hours to produce a leach solution within reported literature containing 11 ppm Au, 5 ppm Ag, 8 ppm Cu, and 10 ppm Fe. Excess-free cyanide was removed via acid titration until the final leach solution was at a pH of 7. Gold was electrochemically adsorbed from the simulated mining leach solution with PVF-CNT electrodes following the scheme in FIG. 7A, and after an applied potential of 0.6 V vs Ag/AgCl for 30 minutes, an uptake of 14.1 mg/g was achieved—aligning well to predicted gold uptake of 15.9 mg/g from Langmuir isotherm model (FIG. 5B). 89.4% of captured gold was electrochemically recovered in 30 minutes via an applied potential of +0.1 V vs Ag/AgCl, and a gold selectivity factor of 13.9 Au:(Ag+Cu+Fe) and final gold purity of 92.9 wt % was achieved (FIGS. 7C and 7D). From these results, it can be concluded that the PVF electrosorption system remains highly selective for the uptake and purification of gold for low-grade mining ores, and the process of leach cyanidation and acid neutralization does not inhibit the recovery performance of PVF-CNT electrosorption.

To expand the applicability of the system further, electronic waste was sourced locally from the University of Illinois Urbana-Champaign surplus electronics department and used to generate real-world cyanidation leach matrices for PVF-enabled electro-recovery and refinement of gold. The electronic waste, an assortment of DDR, DDR2, and DDR3 computer RAM chips (FIG. 7A), was found to contain roughly 1-5 mg gold per gram of waste with major metal elements being Cu, Ni, and Sn from ICP-OES analysis of aqua regia digested E-waste samples. First, E-waste was processed using a traditional recovery method where the waste was crushed, pre-leached with concentrated HCl and H₂O₂ to remove copper, washed with water, and leached in 20 mM KCN with an air bubble to dissolve all remaining gold. The E-waste was crushed to expose bare copper and aid the complete acid digestion of copper. The remaining solids (barren of copper) were washed with water multiple times to remove all traces of acid and copper solution. The traditional method produced an 85.7 wt % gold solution totaling an estimated leach cost of $1,046 per kg of gold leached (FIG. 7B). The major cost factor was the chemical consumption of HCl (69.75 kg/g-_{Au}) and H₂O₂ (162 g/g-Au) for the pre-leaching of copper. The traditional method of gold recovery from electronic waste was economical, however, the process was highly energy-intensive and wasteful of chemical resources—particularly that of water (54 L per g of recovered gold)—to isolate gold from copper waste.

With a highly gold-selective PVF electrosorbent in mind, the gold cyanidation process was optimized to minimize energy, chemical, and water consumption. The optimized leach process consisted of direct cyanidation of uncut E-waste in a dilute 10 mM KCN bath with an air bubble, free cyanide recapture via acidification to a pH of 7, and the PVF electrosorption purification step. Due to the use of gold as a plating material, found only on the surface of electronics, crushing/milling of electronic waste was not required for direct gold cyanidation and resulted in a mixture of gold, copper, nickel, and iron cyano-complexes. The improved process resulted in 70.9 wt % gold after direct cyanidation and 94.6 wt % after PVF electrosorption, with a gold uptake of 207.6 mg/g, a gold recovery efficiency of 91.3% (FIG. 7D), and a gold selectivity factor of 7.2 Au:(Cu+Ni+Fe) (FIG. 7C)—demonstrating clear and effective selective recovery of gold with PVF. The optimized gold electro-recovery process consumed 4.3 KJ/g-_{Au} of energy from electrosorption, with an estimated $7.49 per gold recovered with PVF (FIG. 7B). To summarize the findings: starting from the same electronic waste, the optimized PVF electrosorption process resulted in 10% higher purity gold for 99.3% lower cost while also consuming 94.3% less energy, 99.7% less amount of chemicals, and 54 L/g-_{Au} of water compared to traditional electronic waste recovery methods—clearly improving the economics of electronic waste recycle while lessening environmental impact.

Techno-economic analysis. A detailed techno-economic analysis of the PVF electrosorption system was completed and compared to the leading gold separation technology in the industry—activated carbon-in-pulp. Activated carbon has been industrially utilized as a means of capturing gold-cyanide since 1950, and operates via adsorption of cyano-gold from solution to solid activated carbon in a counter-current adsorption cascade, where gold is eluted (released) then electrowon (electrodeposited), and the barren activated carbon adsorbent is regenerated and reused. For the PVF-based electrosorption, activated carbon was simply replaced with PVF-CNT as the solid adsorbent, and elution and regeneration were done electrochemically. The fundamental similarity of PVF electrosorption and activated carbon adsorption, both being adsorption-based processes, allowed for ease of comparison.

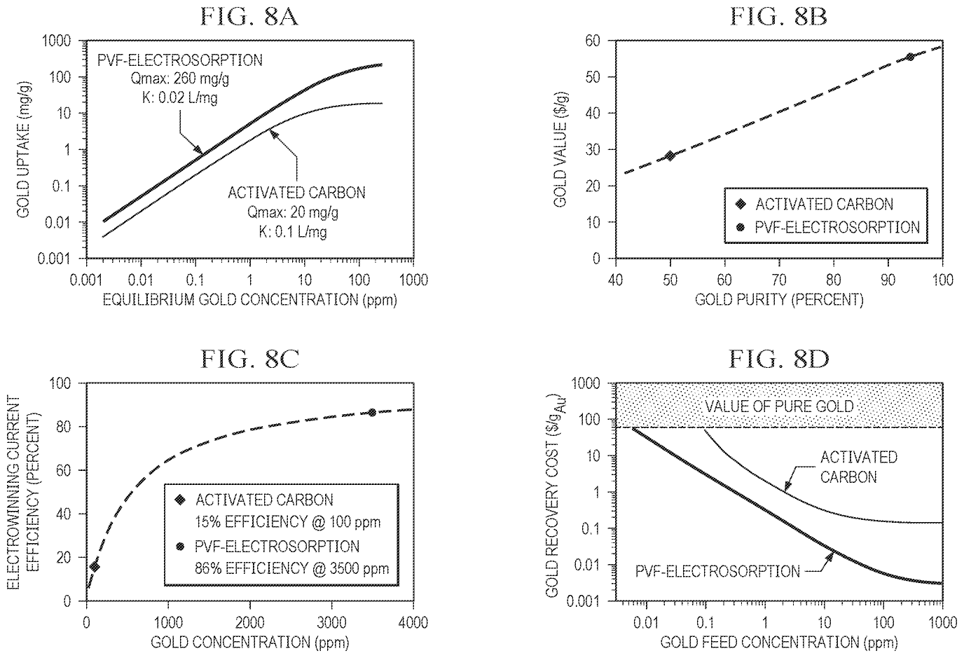

First, comparing gold uptake between PVF and activated carbon (FIG. 8A), PVF electrosorption had consistently higher gold uptake, resulting in a 98.7% reduction in the adsorbent required in circulation. Second, PVF was highly selective toward the uptake of gold over common competing metals (Ag, Cu, Fe, Ni) compared to activated carbon, which is largely non-selective, resulting in an 88.4% increase in recovered gold purity and consequently a 94.7% increase in product value with the PVF system (FIG. 8B). Third, the kinetics of adsorption with PVF was faster than activated carbon resulting in an 82.2% reduction in adsorption tank size. The mechanism of gold release (elution) and adsorbent regeneration was entirely electrically-driven for PVF electrosorption, as opposed to the thermally and chemically intensive elution (Zadra) and regeneration processes for activated carbon. The PVF electrosorption process consumed 35.4% less material and 98.7% less energy for adsorption and desorption compared to activated carbon. Lastly, Zadra elution was found to be water demanding compared to PVF-electrosorption, consuming an estimated 84.8 liters of water per gram gold recovered. Therefore, for water scarce regions, the PVF-electrosorption system can be particularly advantageous for reducing water usage and overall sustainability.

The final stage of gold recovery is the gold electrowinning loop, where gold is released from the adsorbent to a high concentration recirculation loop and finally converted to solid metallic gold in the electrowinning unit. The energy efficiency of gold electrodeposition was directly related to the gold concentration, shown in FIG. 8C, and the concentration of gold in the electrowinning loop is limited by the effectiveness of gold release from the adsorbent to a higher gold concentration. In activated carbon adsorption, effective gold release is typically possible up to a gold concentration of 100 ppm where electrowinning is only 15% efficient, whereas PVF-electrosorption demonstrated effective gold release of >99% at a concentration of 3,500 ppm gold where electrowinning is 86% efficient. The use of PVF-CNT electro-adsorbent over activated carbon resulted in a 90.9% reduction in energy consumption from electrowinning and a 77.7% reduction in electrowinning equipment size (FIG. 8C).

The estimated overall gold separation cost per mass of recovered gold was roughly an order of magnitude lower for the entire range of feed concentration of gold, ranging from 0.006 to 9.85 mg/L Au, favoring the PVF electrosorbent compared to the industrial standard activated carbon (FIG. 8D). This pronounced decrease in gold recovery cost with PVF over activated carbon demonstrates the economic recovery of even lower concentrations of gold using selective electrochemical recovery approaches. Compared to the value of pure gold ($59.77 USD/g as of 2022), gold recovery with the PVF-electrosorption system was economical down to a gold concentration of 6 ppb, whereas activated carbon-based recovery was uneconomical below a gold concentration of 200 ppb.

### CONCLUSIONS

In this investigation, the use of redox-active metallopolymers as electrosorbents for the recovery, purification, and up-concentration of gold from cyanidation leach solutions of both real-world electronic waste and simulated mining ore has been demonstrated. A PVF-CNT electrosorbent was shown to be highly selective to the cyano-gold anion with a selectivity factor of 20:1 relative to competing silver, copper, nickel, and iron combined. The electrosorption kinetics of gold uptake were rapid and followed Langmuir adsorption kinetics well. The electrochemical switching nature of the ferrocene binding site allowed complete release of electro-adsorbed gold within 5 minutes, and unlike traditional adsorbents, the gold release efficiency with PVF-CNT was unaffected by the gold concentration of feed and release streams, allowing concentration of gold from 0.006 mM to 20 mM with a recovery efficiency of 99%. This PVF electrochemical recovery platform selectively captured gold with >200 mg/g uptake from real electronic waste leach streams producing a concentrated stream of 95% pure gold in a single recovery step, clearly demonstrating process intensification of the traditionally multi-step gold refining process. By operating purely on electrical power with an energy usage of 15 KJ/g-_{Au}, the PVF gold recovery system reduces energy consumption by 98.7% while producing 88.4% higher purity gold product, and 84.8 L/g-_{Au} of water was estimated to be saved compared to activated carbon-in-pulp technology, allowing water-scarce regions to more refine gold resources more sustainably. From an industrial standpoint, redox-active metallopolymers may provide a sustainable alternative to conventional activated carbon in gold refining with considerably better technoeconomics, enabling less energy, chemical, and water consumption for the refinement of this valuable resource. With the gradual shift towards electrification and the new paradigm for reducing, reusing, and recycling, electrochemical gold recovery can play a key role in reversing the threat of critical element scarcity.

The subject matter of the disclosure may also relate to the following aspects:

A first aspect relates to an electrochemical method for selective recovery of gold from electronic waste and mining streams, the electrochemical method comprising: selectively electrochemically adsorbing gold complexes from a leach solution onto a redox-active metallopolymer; and electrochemically releasing the gold complexes from the redox-active metallopolymer into a collection fluid.

A second aspect relates to the electrochemical method of the first aspect, wherein the gold complexes comprise anionic gold species.

A third aspect relates to the electrochemical method of the first or second aspect, wherein the gold complexes comprise dicyanoaurate(I) ([Au(CN)₂]⁻), tetracyanoaurate(III), gold(III)-chloride, gold(III)-iodide, gold(III) bromide, auride (Au), gold(I)-thiomalate, and/or gold(I)-thiosulfate.

A fourth aspect relates to the electrochemical method of any preceding aspect, wherein the leach solution is obtained from electronic waste or mining streams.

A fifth aspect relates to the electrochemical method of any preceding aspect, wherein the leach solution includes other metal complexes in addition to the gold complexes.

A sixth aspect relates to the electrochemical method of the preceding aspect, wherein the other metal complexes include silver, iron and/or copper complexes.

A seventh aspect relates to the electrochemical method of any preceding aspect, wherein the redox-active metallopolymer comprises polyvinylferrocene (PVF), polyferrocenyl silane (PFS), poly(3-ferrocenylpropyl methacrylamide (PFPMAm), poly(2-((1-ferrocenylethyl)(methyl)amino)ethyl methacrylate) (PFEMA), and/or poly(2-(methacryloyloxy)ethyl ferrocenecarboxylate) (PFCMA).

An eighth aspect relates to the electrochemical method of any preceding aspect, wherein the redox-active metallopolymer forms part or all of a coating on a conductive substrate.

A ninth aspect relates to the electrochemical method of the preceding aspect, wherein the coating further comprises a carbon-based material.

A tenth aspect relates to the electrochemical method of the preceding aspect, wherein the carbon-based material comprises carbon nanotubes, carbon nanofibers, activated carbon, graphite, and/or graphene.

An eleventh aspect relates to the electrochemical method of any preceding aspect, wherein selectively electrochemically adsorbing the gold complexes onto the redox-active metallopolymer comprises: applying an oxidizing potential to a working electrode including the redox-active metallopolymer, thereby oxidizing neutral sites of the redox-active metallopolymer to form cationic sites; during the application of the oxidizing potential, exposing the redox-active metallopolymer to the leach solution comprising the gold complexes; and selectively adsorbing the gold complexes onto the cationic sites.

A twelfth aspect relates to the electrochemical method of the preceding aspect, wherein the oxidizing potential is in a range from about 0.4 V vs Ag/AgCl to about 1.2 V vs Ag/AgCl.

A thirteenth aspect relates to the electrochemical method of any preceding aspect, wherein the leach solution includes a dilute concentration of the gold complexes, the dilute concentration being in a range from 1-10 ppm and/or from 0.004 mM to 5 mM.

A fourteenth aspect relates to the electrochemical method of any preceding aspect, wherein the redox-active metallopolymer is exposed to a flow of the leach solution.

A fifteenth aspect relates to the electrochemical method of the preceding aspect, further comprising flowing the leach solution at a flow rate in a range from 0.1 mL/min to about 1000 mL/min.

A sixteenth aspect relates to the electrochemical method of any preceding aspect, wherein electrochemically releasing the gold complexes from the redox-active metallopolymer comprises: applying a reducing potential to a working electrode comprising the redox-active metallopolymer, thereby reducing cationic sites of the redox-active metallopolymer to form neutral sites; during the application of the reducing potential, exposing the redox-active metallopolymer to the collection fluid; and releasing the gold complexes from the neutral sites into the collection fluid.

A seventeenth aspect relates to the electrochemical method of the preceding aspect, wherein the reducing potential is in a range from −0.4 V vs Ag/AgCl to +0.4 V vs Ag/AgCl.

An eighteenth aspect relates to the electrochemical method of any preceding aspect, wherein the collection fluid and/or the leach solution includes an electrolyte.

A nineteenth aspect relates to the electrochemical method of the preceding aspect, wherein the electrolyte comprises NaCl, NaClO₄ and/or KCN.

A twentieth aspect relates to the electrochemical method of any preceding aspect, wherein, prior to the electrochemical release of the gold complexes, the collection fluid includes a non-zero concentration of gold species, and/or wherein electrochemically releasing the gold complexes into the collection fluid entails increasing a gold concentration of the collection fluid.

A twenty-first aspect relates to the electrochemical method of any preceding aspect, further comprising: after releasing the gold complexes into the collection fluid, electrodepositing metallic gold onto a conductive substrate from the gold complexes in the collection fluid.

A twenty-second aspect relates to the electrochemical method of the preceding aspect, wherein the electrodeposition comprises: applying an electric reducing potential to the conductive substrate; and during the application of the electric reducing potential, exposing the conductive substrate to the collection fluid including the gold complexes, whereby the metallic gold is deposited on the conductive substrate.

A twenty-third aspect relates to the electrochemical method of any preceding aspect being carried out in a vessel configured for fluid flow, the vessel containing a working electrode comprising the redox-active metallopolymer, and further comprising a counter electrode in the vessel spaced apart from the working electrode.

A twenty-fourth aspect relates to the electrochemical method of the preceding aspect, wherein the counter electrode also includes the redox-active metallopolymer, wherein the working electrode is a first electrode and wherein the counter electrode is a second electrode, and further comprising a cation exchange membrane (CEM) in the vessel between the first and second electrodes, the cation exchange membrane separating a first flow channel containing the first electrode from a second flow channel containing the second electrode.

A twenty-fifth aspect relates to the electrochemical method of the preceding aspect, further comprising: applying an oxidizing potential to the first electrode and applying a reducing potential to the second electrode, and during the application of the oxidizing and reducing potentials, flowing a leach solution through the first flow channel and flowing a collection fluid through the second flow channel, whereby gold complexes from the leach solution are adsorbed onto the redox-active metallopolymer of the first electrode and gold complexes adsorbed onto the redox-active metallopolymer of the second electrode are released into the collection fluid.

A twenty-sixth aspect relates to the electrochemical method of the twenty-fourth or twenty-fifth aspect, further comprising: applying a reducing potential to the first electrode and applying an oxidizing potential to the second electrode, and during the application of the reducing and oxidizing potentials, flowing a collection fluid through the first flow channel and flowing a leach solution through the second flow channel, whereby gold complexes from the leach solution are adsorbed onto the redox-active metallopolymer of the second electrode and gold complexes adsorbed onto the redox-active metallopolymer of the first electrode are released into the collection fluid.

A twenty-seventh aspect relates to the method of any preceding aspect, wherein the leach solution is recirculated for use in multiple cycles of electrochemical adsorption, and/or wherein the collection fluid is recirculated for use in multiple cycles of electrochemical release.

A twenty-eighth aspect relates to the method of any preceding aspect, wherein the leach solution is continuously supplied as fresh leach solution for electrochemical adsorption and then is removed after the electrochemical adsorption as spent leach solution or tailings.

A twenty-ninth aspect relates to an electrochemical system for selective recovery of gold from electronic waste and mining streams, the electrochemical system comprising: a vessel configured for flow of fluid therethrough; a working electrode positioned in the vessel, the working electrode comprising a redox-active metallopolymer; and a counter electrode spaced apart from the working electrode in the vessel.

A thirtieth aspect relates to the electrochemical system of the preceding aspect, wherein the counter electrode also comprises the redox-active metallopolymer, the working electrode being a first electrode and the counter electrode being a second electrode, and further comprising a cation exchange membrane in the vessel between the first and second electrodes, the cation exchange membrane separating a first flow channel containing the first electrode from a second flow channel containing the second electrode.

A thirty-first aspect relates to the electrochemical system of the twenty-ninth or thirtieth aspect, further comprising an electrowinning cell having an inlet in fluid communication with an outlet of the vessel.

A thirty-second aspect relates to the electrochemical system of any preceding aspect, further comprising a source of collection fluid in fluid communication with an inlet of the vessel.

A thirty-third aspect relates to the electrochemical system of the preceding aspect, wherein the source of collection fluid is also in fluid communication with an outlet of the vessel, thereby defining a closed loop for recirculation of the collection fluid through the electrochemical system

A thirty-fourth aspect relates to the electrochemical system of the preceding claim, further comprising an electrowinning cell in the closed loop.

A thirty-fifth aspect relates to the electrochemical system of any preceding aspect, further comprising a source of leach solution in fluid communication with an inlet of the vessel.

A thirty-sixth aspect relates to the electrochemical system of the preceding aspect, wherein the source of leach solution is also in fluid communication with an outlet of the vessel, thereby defining a closed loop for recirculation of the leach solution through the electrochemical system.

A thirty-seventh aspect relates to the electrochemical system of any preceding aspect, including one or more valves and one or more pumps for controlling flow of a leach solution and a collection fluid through the electrochemical system.

A thirty-eighth aspect relates to the electrochemical system of the preceding aspect, wherein the one or more valves include one or more rotary valves and/or one or more check valves.

A thirty-ninth aspect relates to the electrochemical system of any preceding aspect, further comprising a power supply electrically connected to or configured for electrical connection to the working and counter electrodes.

A fortieth aspect relates to the electrochemical system of any preceding claim, wherein the redox-active metallopolymer comprises polyvinylferrocene (PVF), polyferrocenyl silane (PFS), poly(3-ferrocenylpropyl methacrylamide (PFPMAm), poly(2-((1-ferrocenylethyl)(methyl)amino)ethyl methacrylate) (PFEMA), and/or poly(2-(methacryloyloxy)ethyl ferrocenecarboxylate) (PFCMA).

A forty-first aspect relates to the electrochemical system of the preceding aspect, wherein the redox-active metallopolymer forms part or all of a coating on the working electrode.

A forty-second aspect relates to the electrochemical system of the preceding aspect, wherein the coating further comprises a carbon-based material.

A forty-third aspect relates to the electrochemical system of the preceding aspect, wherein the carbon-based material comprises carbon nanotubes, carbon nanofibers, activated carbon, graphite, and/or graphene.

A forty-fourth aspect relates to an electrode for recovery of gold from electronic waste and mining streams, the electrode comprising: a conductive substrate; and a redox-active metallopolymer on the conductive substrate.

A forty-fifth aspect relates to the electrode of the forty-fourth aspect, wherein the redox-active metallopolymer comprises polyvinylferrocene (PVF), polyferrocenyl silane (PFS), poly(3-ferrocenylpropyl methacrylamide (PFPMAm), poly(2-((1-ferrocenylethyl)(methyl)amino)ethyl methacrylate) (PFEMA), and/or poly(2-(methacryloyloxy)ethyl ferrocenecarboxylate) (PFCMA).

A forty-sixth aspect relates to the electrode of the forty-fourth or forty-fifty aspect, wherein the redox-active metallopolymer forms part or all of a coating on the conductive substrate.

A forty-seventh aspect relates to the electrode of the preceding aspect, wherein the coating further comprises a carbon-based material.

A forty-eighth aspect relates to the electrode of the preceding aspect, wherein the carbon-based material comprises carbon nanotubes, carbon nanofibers, activated carbon, graphite, and/or graphene.

To clarify the use of and to hereby provide notice to the public, the phrases “at least one of <A>, <B>, . . . and <N>” or “at least one of <A>, <B>, . . . or <N>” or “at least one of <A>, <B>, . . . <N>, or combinations thereof” or “<A>, <B>, . . . and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various embodiments have been described, it will be apparent to those of ordinary skill in the art that many more embodiments and implementations are possible. Accordingly, the embodiments described herein are examples, not the only possible embodiments and implementations.

In addition to the features mentioned in each of the independent aspects enumerated above, some examples may show, alone or in combination, the optional features mentioned in the dependent aspects and/or as disclosed in the description above and shown in the figures.

1. An electrochemical method for selective recovery of gold from electronic waste and mining streams, the electrochemical method comprising:
selectively electrochemically adsorbing gold complexes from a leach solution onto a redox-active metallopolymer; and
electrochemically releasing the gold complexes from the redox-active metallopolymer into a collection fluid.

2. The electrochemical method of claim 1, wherein the gold complexes comprise anionic gold species.

3. The electrochemical method of claim 1, wherein the leach solution is obtained from electronic waste or mining streams.

4. The electrochemical method of claim 1, wherein the leach solution includes other metal complexes in addition to the gold complexes.

5. The electrochemical method of claim 1, wherein the redox-active metallopolymer comprises polyvinylferrocene (PVF), polyferrocenyl silane (PFS), poly(3-ferrocenylpropyl methacrylamide (PFPMAm), poly(2-((1-ferrocenylethyl)(methyl)amino)ethyl methacrylate) (PFEMA), and/or poly(2-(methacryloyloxy)ethyl ferrocenecarboxylate) (PFCMA).

6. The electrochemical method of claim 1, wherein the leach solution includes a dilute concentration of the gold complexes, the dilute concentration being in a range from 1-10 ppm and/or from 0.004 mM to 5 mM.

7. The electrochemical method of claim 1, further comprising:
after releasing the gold complexes into the collection fluid, electrodepositing metallic gold onto a conductive substrate from the gold complexes in the collection fluid.

8. The electrochemical method of claim 1 being carried out in a vessel configured for fluid flow, the vessel containing a working electrode comprising the redox-active metallopolymer, and further comprising a counter electrode in the vessel spaced apart from the working electrode.

9. The electrochemical method of claim 8, wherein the counter electrode also includes the redox-active metallopolymer,
wherein the working electrode is a first electrode and wherein the counter electrode is a second electrode, and
further comprising a cation exchange membrane (CEM) in the vessel between the first and second electrodes, the cation exchange membrane separating a first flow channel containing the first electrode from a second flow channel containing the second electrode.

10. The electrochemical method of claim 9, further comprising:
applying an oxidizing potential to the first electrode and applying a reducing potential to the second electrode, and
during the application of the oxidizing and reducing potentials, flowing a leach solution through the first flow channel and flowing a collection fluid through the second flow channel,
whereby gold complexes from the leach solution are adsorbed onto the redox-active metallopolymer of the first electrode and gold complexes adsorbed onto the redox-active metallopolymer of the second electrode are released into the collection fluid.

11. The electrochemical method of claim 9, further comprising:
applying a reducing potential to the first electrode and applying an oxidizing potential to the second electrode, and
during the application of the reducing and oxidizing potentials, flowing a collection fluid through the first flow channel and flowing a leach solution through the second flow channel,
whereby gold complexes from the leach solution are adsorbed onto the redox-active metallopolymer of the second electrode and gold complexes adsorbed onto the redox-active metallopolymer of the first electrode are released into the collection fluid.

12. The method of claim 1, wherein the leach solution is recirculated for use in multiple cycles of electrochemical adsorption, and/or
wherein the collection fluid is recirculated for use in multiple cycles of electrochemical release.

13. The method of claim 1, wherein the leach solution is continuously supplied as fresh leach solution for electrochemical adsorption and then is removed after the electrochemical adsorption as spent leach solution or tailings.

14. An electrochemical system for selective recovery of gold from electronic waste and mining streams, the electrochemical system comprising:
a vessel configured for flow of fluid therethrough;
a working electrode positioned in the vessel, the working electrode comprising a redox-active metallopolymer; and
a counter electrode spaced apart from the working electrode in the vessel.

15. The electrochemical system of claim 14, wherein the counter electrode also comprises the redox-active metallopolymer, the working electrode being a first electrode and the counter electrode being a second electrode, and
further comprising a cation exchange membrane in the vessel between the first and second electrodes, the cation exchange membrane separating a first flow channel containing the first electrode from a second flow channel containing the second electrode.

16. The electrochemical system of claim 14, further comprising an electrowinning cell having an inlet in fluid communication with an outlet of the vessel.

17. The electrochemical system of claim 14, further comprising a source of collection fluid in fluid communication with an inlet and an outlet of the vessel, thereby defining a closed loop for recirculation of the collection fluid through the electrochemical system.

18. The electrochemical system of claim 14, further comprising a source of leach solution in fluid communication with an inlet and an outlet of the vessel, thereby defining a closed loop for recirculation of the leach solution through the electrochemical system.

19. The electrochemical system of claim 14, wherein the redox-active metallopolymer comprises polyvinylferrocene (PVF), polyferrocenyl silane (PFS), poly(3-ferrocenylpropyl methacrylamide (PFPMAm), poly(2-((1-ferrocenylethyl)(methyl)amino)ethyl methacrylate) (PFEMA), and/or poly(2-(methacryloyloxy)ethyl ferrocenecarboxylate) (PFCMA).

20. An electrode for recovery of gold from electronic waste and mining streams, the electrode comprising:
a conductive substrate; and
a redox-active metallopolymer on the conductive substrate.
